(19) United States
(12) Patent Application Publication
(10) Pub. No.: US 2002/0152224 A1
(43) Pub. Date: Oct. 17, 2002

(54) System and method for generating a recommendation guide for use with an EPG

(76) Inventors: Cliff Roth, New York, NY (US); Paul Finster, New York, NY (US); Jonathan Greenberg, New York, NY (US); David Ruderman, Brooklyn, NY (US); William Shine, New York, NY (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/087,516

(22) Filed: Mar. 2, 2002

Related U.S. Application Data
(60) Provisional application No. 60/273,346, filed on Mar. 6, 2001.

(51) Int. Cl. G06F 7/00

(52) U.S. Cl. 707/104.1

(57) ABSTRACT

A system and method for generating and displaying customized electronic programming (EPG) data is described. One exemplary method includes the steps of retrieving a plurality of category preferences associated with a user; retrieving a list of displayable program indicators for each of the plurality of category preferences, wherein each of the program indicators included in the list of displayable program indicators is associated with a start time; retrieving program data for each of the program indicators included in the list of displayable program indicators; and providing the retrieved program data for display.

### PRIORITY

This application claims priority from U.S. provisional patent application No. 60/273,346, entitled System and Method for Providing an Onscreen Interactive Program Guide, filed on Mar. 6, 2001, which is incorporated herein by reference.

### FIELD OF THE INVENTION

The present invention relates generally to electronic program guides (EPGs). In particular, but not by way of limitation, the present invention relates to customized EPG data and recommendation guides.

### BACKGROUND OF THE INVENTION

As the number of available TV channels increases, the need for more sophisticated program guides also increases. Although newspaper listings and magazines were adequate when TV viewers received a few dozen channels, they are inadequate when viewers receive hundreds of channels as they do with satellite TV and digital cable.

To help viewers better manage their program listings, EPGs were developed. Early EPGs provided programming information in the vertical blanking interval (VBI) of an analog TV signal. A set-top box (STB) connected to the viewer's TV would extract the program information from the VBI, parse it, and display it for the viewer. In this type of system, the STB generally received more information than the viewer required and, thus, the STB was forced to sort the information to present only the relevant data. Obviously, these early systems had significant drawbacks such as high bandwidth usage and the need for proprietary code in the STBs to interpret the received programming information. In fact, the need for proprietary code in each STB meant that early EPGs were extremely difficult to deploy across varied types of STBs.

With the development of digital cable and satellite TV systems, STBs were significantly redesigned. For example, the digitally-enabled STBs generally include a middleware layer on top of a PC-type hardware layer, and depending upon the manufacture and model of the STB, the middleware layer can include browser-type functionality and/or an interpreted language engine such as a JavaScript engine. By incorporating browser-type functionality and/or an interpreted language engine into an STB, EPG applications can be more easily transported from one type of STB to another.

Although EPGs have been developed for digitally-enabled STBs, these EPGs have failed to fully take advantage of the new technology. With the increased number of available channels, present EPGs are less effective in helping users quickly locate programs of interest. For example, present EPGs do not adequately utilize the two-way interactive capabilities of digital cable and similar content delivery systems to help customize the program listings offered to a viewer. Accordingly, a system and method are needed to take advantage of new technology and to overcome problems with the existing technology.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention includes a system and method for generating a recommendation guide based upon user preferences. In one embodiment, the recommendation guide is displayed in the form of a grid with the rows representing time periods and the columns representing preferred categories. Recommended programs can be displayed in the grid according to time and category. The particular categories displayed for a viewer are customizable according to viewer preferences.

The list of recommended programs can be generated at an EPG provider and customized by the viewer. For example, recommended programs—as determined by a content provider or EPG provider—can be supplemented by the viewer's preferred programs. In other embodiments, programs that are otherwise included in the list of recommended programs can be removed. For example, if the user does not like a particular recommended program, that program can be removed from the list and not displayed in the grid or in future grids.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a system constructed according to the principles of the present invention;

FIG. 2 is a block diagram of the STB shown in FIG. 1;

FIG. 3 is a flowchart of one method for generating and providing preference-based programming information to an STB; and

FIG. 4 illustrates a recommendation guide in accordance with the principles of the present invention.

### DETAILED DESCRIPTION

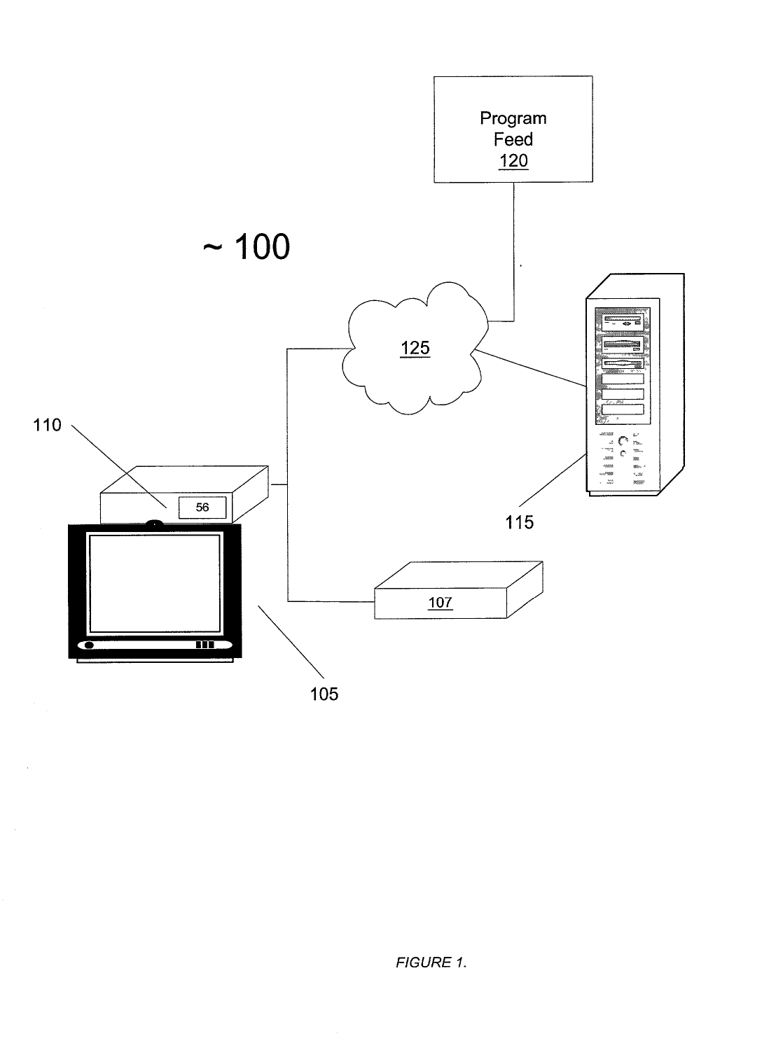

Referring now to the drawings, where like or similar elements are designated with identical reference numerals throughout the several views, and referring first to FIG. 1, it illustrates a system 100 constructed in accordance with the principles of the present invention. In this embodiment, a TV 105, video monitor or other display is connected to any STB 110 that is equipped with two-way interactive capabilities and a personal video recorder (PVR) 107. The STB 110 can receive data from external sources such as an EPG server 115, a program feed 120, or the PVR 107 and can transmit data back to those external sources. Although the STB 110 is shown as a separate unit from the TV 105, it can be integrated therein.

In this embodiment, the STB 110 is configured to receive programming from a program feed 120 through the network 125. Similarly, the STB 110 is configured to receive EPG data, e.g., programming information and recommendation information, from an EPG server 115. Notably, the STB 110 can be configured to receive both programming and EPG data in a digital format. Thus, the STB 110 can be configured to manipulate the data by, for example, compression and decompression techniques.

Because the STB 110 is equipped with two-way interactive capabilities, the STB 110 can advantageously provide information to the program feed 120 and to the EPG server 115. For example, the STB 110 can provide the program feed 120 with information regarding Pay Per View requests. Similarly, the STB 110 can provide the EPG server 115 with information regarding a viewer's EPG preferences. These STB features are discussed in more detail with regard to the subsequent figures.

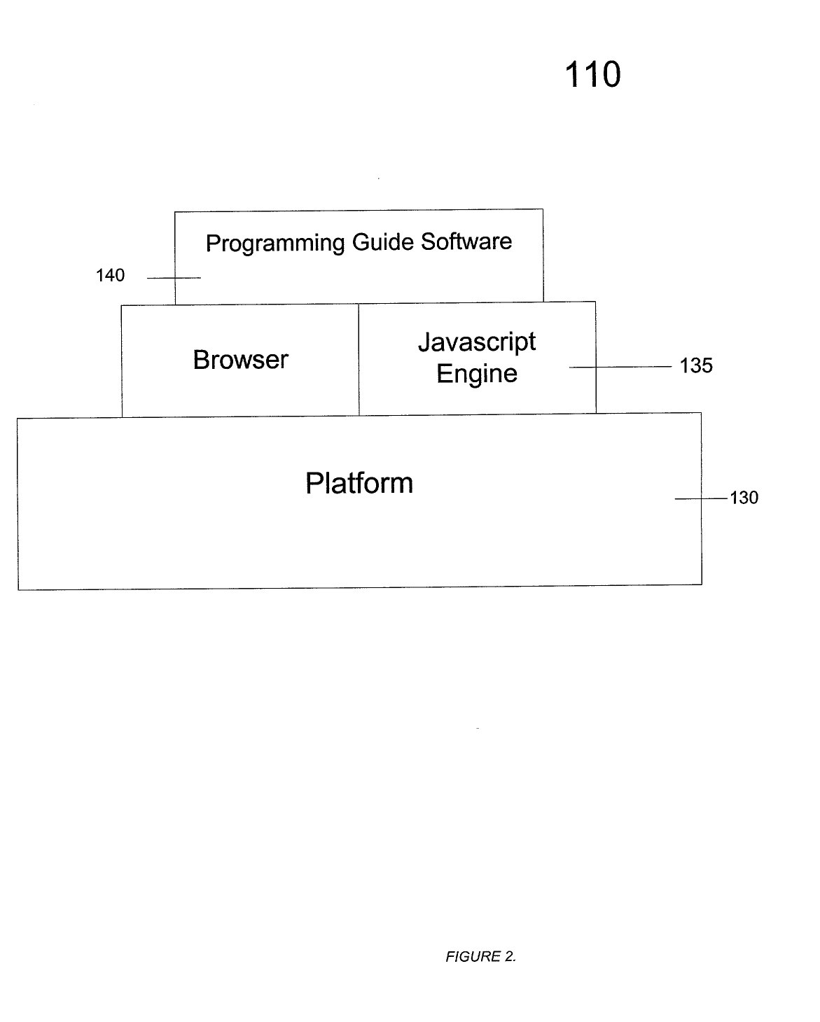

Referring now to FIG. 2, it illustrates a block diagram of an STB 110 as shown in FIG. 1. This STB 110 includes a platform layer 130, than includes at least a processor and memory; a middleware layer 135 that includes a browser and/or an interpreted language engine such as a JavaScript engine or virtual machine; and programming guide software 140. The configuration of STBs varies widely because there are several different manufacturers. Basic digital STBs, for example, are manufactured by several companies including: Pace, Samsung, Zenith, Philips, Motorola and Scientific-Atlanta. Similarly, the middleware configuration varies because companies such as Liberate, OpenTV and Microsoft offer their own products with their own functions. Embodiments of the present invention, however, can incorporate most any STB 110. In fact, programming guide software 140 constructed according to the principles of the present invention, can be adapted to operate on the many different platforms 130 and middleware 135 that are currently available or that will be available in the future.

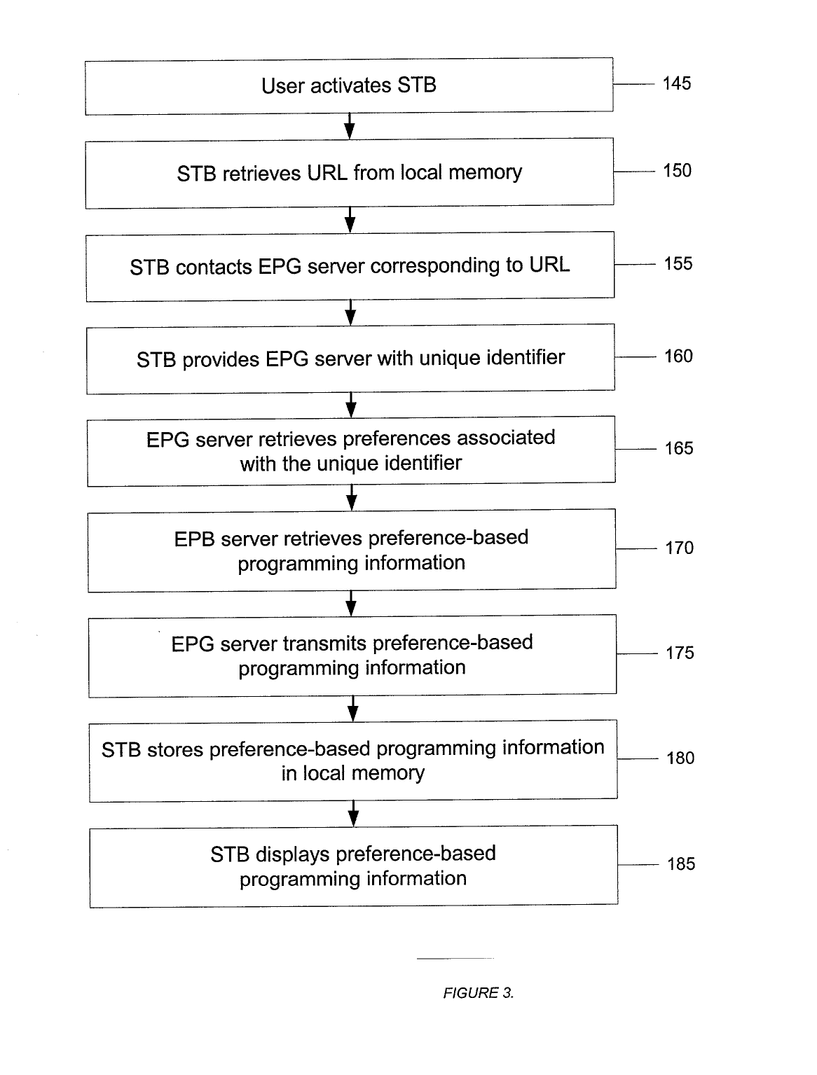

Referring now to FIG. 3, it is a flowchart of one method for providing preference-based, i.e., customized, preference-based programming information to an STB 110. In this embodiment, a viewer initially activates an STB (step 145). For example, the viewer could activate the STB 110 for the first time after receiving cable service or turn on the STB 110 after a period of non-use. The STB 110, in response to being activated, retrieves an external contact address, such as a URL, from local memory and attempts to contact that external address for instructions (steps 150 and 155). Assuming that the contact address is associated with an EPG server 115, the EPG server 115 can establish the identity of the STB 110 by reading a unique identifier from the STB 110 or receiving the unique identifier from the STB 110 (step 160).

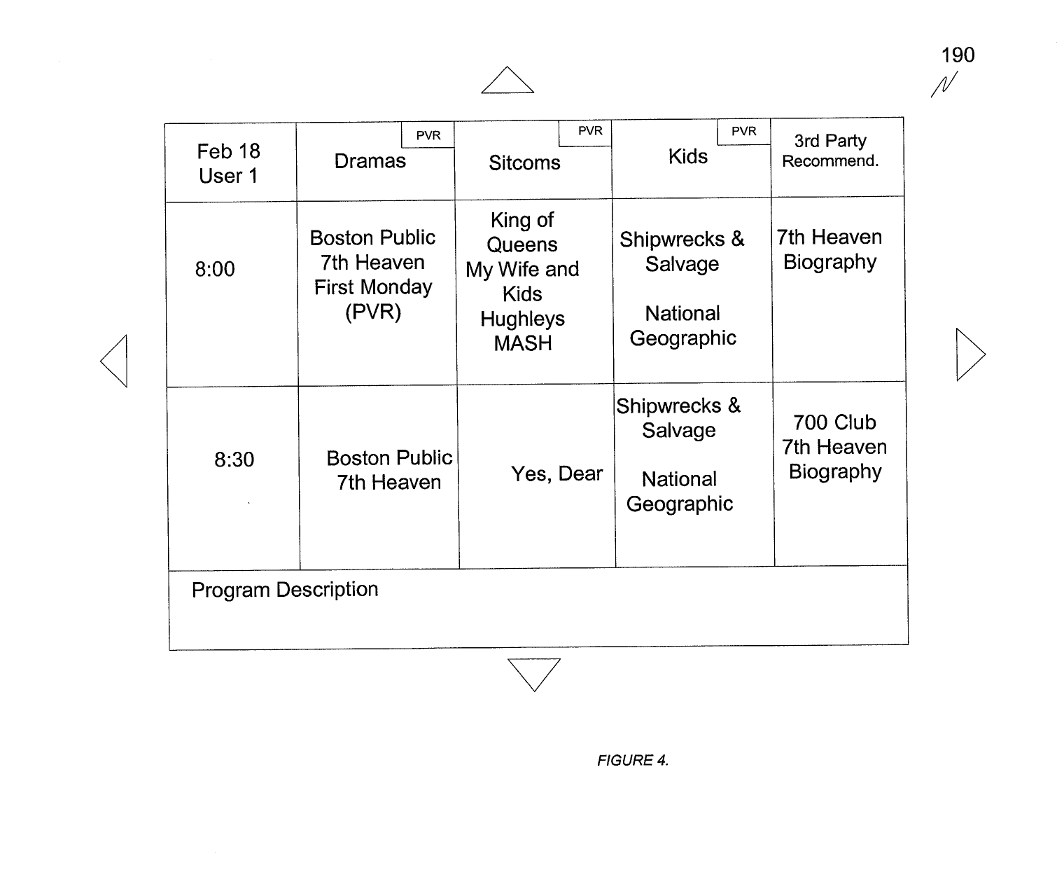

Once the EPG server 115 identifies the STB 110 with which it is communicating, the EPG server 115 determines the EPG preferences associated with the STB, such as recommendation guide preferences (step 165). For example, the EPG server 115 may determine that the viewer wants to see recommendations for “Drama” and “Sci-Fi” categories at 8:00. An example of the recommendation guide configured according to user preferences is shown in FIG. 4 and is discussed in detail below.

The EPG server 115 may also determine the time of the last download to the STB 110 and the new amount of data needed to keep the STB 110 updated. For example, if the STB 110 should locally store two future weeks of recommendation information and the last download to the STB 110 was two days ago, then the STB 110 needs only two additional days of data rather than the full two weeks.

After the EPG server 115 has determined the viewer's preferences and, if required, the amount of needed programming information, the EPG server 115 retrieves or generates the relevant programming information and any related data (step 170). The EPG server 115 can retrieve the relevant information by sorting a larger database of all programming information or by joining tables that contain certain pieces of the information. The EPG server 115, for example, could dynamically assemble the customized programming information or could retrieve a previously generated block of programming information corresponding to the viewer's preferences. In either embodiment, however, once the relevant programming information is identified, the EPG server 115 can assemble the data and transmit it to the STB 110 (step 175). By assembling the information at the EPG server 115, the STB 110 is not necessarily required to parse the programming information, and thus, does not need to know a substantial amount about the received programming information beyond how to display it. In one embodiment, however, the STB 110 could sort some or all of the programming information received from the EPG server 115.

Still referring to FIG. 3, once the STB 110 receives the programming information, the STB 110 can store that data locally in, for example, a high-speed memory (step 180). Upon request by the viewer, the STB 110 can retrieve the relevant portions of the programming information and display them either in a standardized fashion or a customized fashion (step 185). Notably, the programming information can be displayed by the middleware browser or JavaScript engine.

Referring now to FIG. 4, it illustrates a recommendation guide display 190 generated in accordance with the principles of the present invention. Instead of displaying the program listings according to channel and time, this implementation of the recommendation guide arranges the program listings by category and time. Additionally, the recommendation guide can display only those programs that are selected by the viewer or recommended for the viewer. For example, an EPG provider, or associated service, could generate a list of programs according to categories and/or subcategories, e.g., dramas and medical dramas. The programs in the various categories can be manually identified by an editorial staff and customized by the viewer as desired, or the relevant programs can be automatically identified through an electronic filtering process. Advantageously, an EPG provider can provide a viewer with pre-selected programs in each category rather than require the viewer to build each category from scratch.

This embodiment of the recommendation guide includes a display with three rows, five columns, and a program information area. For example, this version of the recommendation guide display 190 includes the categories: “Dramas,” “Sitcoms,” “Kids,” and “3rd Party Recommendations.” The “3rd Party Recommendations” category can be populated by an outside source, e.g., an independent reviewer, that provides recommendations to the EPG provider or the recommendation guide. Other categories can be defined by the viewer or the EPG provider. Exemplary categories include ratings, date ranges, top rated by viewer, top rated by critics, top rated by area, most popular currently, celebrities, show attributes, originality, new releases, interactive content, genre, and advertisements. Notably, the displayed order of the columns can be customized by the viewer. For example, other column choices could include “Sports” and “Movies,” and instead of displaying these columns in the initial (or primary) display, the viewer can scroll the display using the left or right arrow to see them.

To view the recommendation guide, the viewer can activate it from, for example, a typical EPG or through some other interaction. Once activated, the recommendation guide, through functionality stored on the STB, can retrieve preferences associated with the viewer. Preferences can include data such as column descriptors, e.g., “Dramas,” “Sitcoms,” service tier (broadcast, premium cable, etc.) and program listing preferences. These preferences can be associated with the STB, i.e., only one set of preferences per STB, or the preferences can be associated with the individual viewer as identified to the recommendation guide, i.e., one set of preferences per user. Additionally, the recommendation guide can retrieve the preference data from a memory local to the STB or a memory remote from the STB, such as at the EPG provider.

After retrieving the preference data, the recommendation guide can retrieve the programming data. For example, assume that the preference data indicated that the viewer wanted columns “Drama,” “Sitcoms,” and “Kids,” the recommendation guide could retrieve the program recommendations for those categories, or it could retrieve recommendations for all of the categories and sort the data locally. In an alternate embodiment, the recommendation guide would check to see if fresh recommendation data was stored locally and only request data from the EPG provider if the data that was not available locally.

Once the program listing data is received, the recommendation guide could check that data against the viewer's program listing preferences. For example, if the viewer indicated that he was not interested in the program My Wife and Kids, but it was included in the recommendation data received from the EPG provider, the recommendation guide could screen out that recommendation so that My Wife and Kids would not be included. In other words, the recommendation guide allows the viewer to remove programs from the list of recommended programs.

In another embodiment, programs that are not otherwise included in the recommendation data can be added to the list of recommended programs. For example, the viewer can select programs of interest or the recommendation guide can monitor the viewer's selected programs and identify programs of interest (collectively referred to as “preferred” programs.) These selected or identified programs can then be added to the recommendation data as appropriate.

To add programs to the list of recommended programs, the recommendation guide compiles a list of preferred programs and provides that list to the EPG provider. The EPG provider then determines whether any of the target programs are being offered in the relevant time frame, which is the time frame that the viewer has selected to view. If any of the target programs are being offered in the relevant time frame, then the corresponding information is provided from the EPG provider to the recommendation guide. Alternatively, the recommendation guide could extract information about the programs of interest from data already provided to the viewer. In one embodiment, the recommendation guide extracts and processes the relevant information from EPG data previously provided to the viewer. For example, assuming that a viewer selects MASH as a preferred program, the recommendation guide could request data related to MASH for the relevant time frame. If MASH is available, the title could be displayed in a “Favorites” column or an existing column such as in FIG. 4 where MASH is displayed in the “Sitcom” column.

In one embodiment, the viewer can indicate that a particular episode has been viewed, and the recommendation guide can screen data related to the previously viewed episode. Thus, for a program that is offered, for example, several times in a week, the recommendation guide can determine whether the program has been viewed, and if it has been viewed, the recommendation guide can screen future showings from the recommendation data.

In another embodiment of the recommendation guide, it is linked with a PVR. When programs are recorded, they can be associated with a category indicator corresponding to the recommendation guide categories. The PVR recordings can then be displayed in a column of PVR recordings or in a column of recommendation guide categories. For example, each of the recommendation guide categories could be associated with a PVR listing button. When that button is selected, the PVR recordings for that category are displayed. First Monday in the “Drama” category is such a PVR recording.

The recommendation guide can also present viewers with search options, recommendation sharing options, and data import options. For example, one embodiment of the recommendation guide allows the viewer to search by program name, celebrity, cast, subjects, keywords, text, etc. The recommendation sharing option allows viewers to exchange recommendations directly between STBs and by other electronic mechanisms. The data import options allows data to be imported from electronic calendars and task lists included on electronic devices such as PDAS.

In conclusion, the present invention provides, among other things, a system and method for generating and displaying customized EPG data. Those skilled in the art can readily recognize that numerous variations and substitutions may be made in the invention, its use and its configuration to achieve substantially the same results as achieved by the embodiments described herein. For example, the embodiments of the present invention can be implemented in any Virtual Machine architecture that provides a display engine and an execution engine. Accordingly, there is no intention to limit the invention to the disclosed exemplary forms. Many variations, modifications and alternative constructions fall within the scope and spirit of the disclosed invention as expressed in the claims.

What is claimed is:

1. A method for generating an electronic program listing recommendation guide, the method comprising:
receiving a request from a user to generate a recommendation guide;
retrieving category preferences associated with the user;
retrieving a list of restricted program indicators;
retrieving a list of preferred program indicators;
retrieving a list of recommended program indicators, the program indicators included in the list of recommended program indicators corresponding to at least one of the retrieved category preferences;
generating a list of displayable program indicators, wherein the list of displayable program indicators includes program indicators included in the list of preferred program indicators and program indicators included in the list of recommended program indicators but not included in the list of restricted program indicators; and
displaying program indicators included in the generated list of displayable program indicators, wherein the displayed program indicators are arranged according to the retrieved category preferences.

2. The method of claim 1, further comprising:
transmitting the generated list of displayable program indicators to a set-top box associated with the user.

3. The method of claim 1, wherein the restricted program indicators correspond to program indicators included in the list of recommended program indicators.

4. The method of claim 1, wherein at least one of the program indicators included in the list of preferred program indicators is not included in the list of recommended programs.

5. A method for generating an electronic program listing recommendation guide, the method comprising:
retrieving a plurality of category preferences associated with a user;
retrieving a list of displayable program indicators for each of the plurality of category preferences, wherein each of the program indicators included in the list of displayable program indicators is associated with a start time;
retrieving program data for each of the program indicators included in the list of displayable program indicators; and
providing the retrieved program data for display.

6. The method of claim 5, further comprising:
displaying the retrieved program data for a first program indicator included in the list of displayable program indicators, wherein the retrieved program data for the first program indicator is displayed in association with a first category included in the plurality of category preferences, wherein the first category corresponds with the first program indicator.

7. The method of claim 6, further comprising:
displaying the retrieved program data for a second program indicator included in the list of displayable program indicators, wherein the retrieved program data for the second program indicator is displayed in association with a first category included in the plurality of category preferences, wherein the second category corresponds with the second program indicator.

8. The method of claim 7, further comprising:
displaying the first program indicator and an indicator of the first category in a first column; and
displaying the second program indicator and an indicator of the second category in a second column.

9. The method of claim 7, further comprising:
displaying the first program indicator and an indicator of the first category in a first row; and
displaying the second program indicator and an indicator of the second category in a second row.

10. The method of claim 5, wherein the list of displayable program indicators comprises:
a list of recommended programs.

11. The method of claim 10, further comprising:
receiving the list of recommended programs from a remote source.

12. The method of claim 5, further comprising:
identifying a restricted program indicator, the restricted program indicator being selectable by the user;
wherein the list of displayable program indicators does not include the restricted program indicator.

13. The method of claim 12, further comprising:
removing the restricted program indicator from the list of displayable programs.

14. The method of claim 5, further comprising:
identifying a preferred program indicator, the preferred program indicator being selectable by the user,
wherein the list of displayable program indicators includes the preferred program indicator.

15. The method of claim 14, further comprising:
adding the preferred program indicator to the list of displayable programs indicators.

16. The method of claim 5, further comprising:
identifying a previously viewed program, the previously viewed program being associated with a target program indicator;
locating the target program indicator in the list of displayable program indicators; and
removing the target program indicator from the list of displayable program indicators.

17. The method of claim 5, further comprising:
identifying a previously viewed program, the previously viewed program being associated with a target program indicator;
locating the target program indicator in the list of displayable program indicators; and
assigning a low display priority to the target program indicator included in list of displayable program indicators.

18. The method of claim 5, wherein the plurality of category preferences are customizable by the user.

19. A system for generating an electronic program listing recommendation guide, the system comprising:
means for retrieving a plurality of category preferences associated with a user;
means for retrieving a list of displayable program indicators for each of the plurality of category preferences, wherein each of the program indicators included in the list of displayable program indicators is associated with a start time;
means for retrieving program data for each of the program indicators included in the list of displayable program indicators; and
means for providing the retrieved program data for display.

20. The system of claim 19, wherein the list of displayable program indicators comprises:
a list of recommended programs.

21. The system of claim 20, further comprising:
means for receiving the list of recommended programs from a remote source.

22. The system of claim 21, further comprising:
identifying a restricted program indicator, the restricted program indicator being selectable by the user;
wherein the list of displayable program indicators does not include the restricted program indicator.

23. The system of claim 22, further comprising:
means for removing the restricted program indicator from the list of displayable programs.

24. The system of claim 22, further comprising:
means for identifying a preferred program indicator, the preferred program indicator being selectable by the user;
wherein the list of displayable program indicators includes the preferred program indicator.

25. The system of claim 24, further comprising:
means for adding the preferred program indicator to the list of displayable programs indicators.

26. The system of claim 24, further comprising:
means for identifying a previously viewed program, the previously viewed program being associated with a target program indicator;
means for locating the target program indicator in the list of displayable program indicators; and
means for removing the target program indicator from the list of displayable program indicators.

27. The system of claim 19, further comprising:
means for identifying a previously viewed program, the previously viewed program being associated with a target program indicator;
means for locating the target program indicator in the list of displayable program indicators; and
means for assigning a low display priority to the target program indicator included in list of displayable program indicators.
